(19) United States
(12) Patent Application Publication
(10) Pub. No.: US 2019/0165413 A1
(43) Pub. Date: May 30, 2019

(54) LITHIUM-ION SECONDARY BATTERY

(71) Applicant: SEIKO EPSON CORPORATION, Tokyo (JP)

(72) Inventor: Masahiro FURUSAWA, Chino-shi (JP)

(73) Assignee: SEIKO EPSON CORPORATION, Tokyo (JP)

(21) Appl. No.: 16/300,430

(22) PCT Filed: Apr. 27, 2017
(86) PCT No.: PCT/JP2017/016862

§ 371 Date: Nov. 9, 2018

(30) Foreign Application Priority Data
May 13, 2016 (JP) 2016-097127

(51) Int. Cl. H01M 10/0525; H01M 10/0562; H01M 4/02

(52) U.S. Cl. CPC H01M 10/0525; H01M 10/0562; H01M 2004/027; H01M 2004/028; H01M 4/02

(57) ABSTRACT

A large-capacity lithium-ion secondary battery also suitable for low voltage applications, including a substrate and a stacked body in which a battery layer and a collector electrode layer are alternately stacked on the substrate, wherein the battery layer has a positive electrode active material layer, a negative electrode active material layer, and an electrolyte layer between the positive electrode active material layer and the negative electrode active material layer, and each of the collector electrode layers has an extraction electrode planarly disposed on the substrate.

### TECHNICAL FIELD

The present invention relates to a lithium-ion secondary battery.

### BACKGROUND ART

As a power supply for many electrical apparatuses such as portable information apparatuses, a lithium-ion secondary battery has been used. Among lithium-ion secondary batteries, as a lithium-ion secondary battery achieving both a high energy density and safety, an all-solid-state lithium-ion secondary battery using a solid electrolyte for conduction of lithium ions between positive and negative electrodes has been proposed. The all-solid-state lithium-ion secondary battery can be classified into two types: “bulk type” and “thin film type”.

A bulk-type all-solid-state lithium-ion secondary battery has substantially the same configuration as a battery using an electrolytic solution, but is a battery using a solid electrolyte in place of the electrolytic solution. The bulk-type all-solid-state lithium-ion secondary battery has an advantage in that the capacity thereof can be increased, however, a powder process is used for forming the solid electrolyte, and therefore, it is difficult to decrease a contact resistance in the solid electrolyte, and thus, the practical application thereof has not yet been reached.

On the other hand, a thin film-type all-solid-state lithium-ion secondary battery has an advantage in that it can be easily formed by a thin film formation process such as vacuum deposition or sputtering. The thin film-type all-solid-state lithium-ion secondary battery has difficulty in increasing its capacity with a single layer, however, the capacity thereof can be increased by stacking a plurality of batteries and connecting the batteries in series. As an example of stacking a plurality of batteries, a bi-polar battery in which a plurality of bi-polar electrodes provided with a positive electrode and a negative electrode on both surfaces of one current collector are stacked through a solid electrolyte, and the like are exemplified (PTL 1).

However, in the case where a plurality of batteries are stacked by connection in series as described above, the voltage is increased, and therefore, a battery produced by such a stacking method was not suitable for a power supply for small-sized electronic apparatuses for which a low voltage is required.

### CITATION LIST

### Patent Literature

PTL 1: JP-A-2004-071405

### SUMMARY OF INVENTION

### Technical Problem

The invention has been made in view of at least such a circumstance, and an object thereof is to provide a large-capacity lithium-ion secondary battery also suitable for low voltage applications.

### Solution to Problem

In order to achieve the above-mentioned object, one aspect of the invention provides a lithium-ion secondary battery including a substrate and a stacked body in which a plurality of unit battery layers and a plurality of collector electrode layers are alternately stacked on the substrate, wherein the collector electrode layer is disposed at each of the both ends in the stacking direction of the stacked body, the unit battery layer has a positive electrode active material layer, a negative electrode active material layer, and a solid electrolyte layer interposed between the positive electrode active material layer and the negative electrode active material layer, each of the collector electrode layers has an extraction electrode, and the plurality of extraction electrodes are planarly disposed on the substrate.

According to this configuration, the unit battery layers can be connected in parallel through the plurality of extraction electrodes planarly disposed on the substrate. According to this, a large-capacity lithium-ion secondary battery also suitable for low voltage applications is obtained.

The aspect of the invention may adopt a configuration in which in the stacked body, the plane area of another layer formed on each of the collector electrode layers is smaller than the plane area of the collector electrode layer.

According to this configuration, a part of the upper surface of each of the collector electrode layers is exposed, and therefore, a plurality of extraction electrodes can be formed in the exposed portion of each of these collector electrode layers. As a result, the plurality of extraction electrodes can be planarly disposed efficiently on the substrate. According to this, the unit battery layers can be connected in parallel through these extraction electrodes, and thus, a large-capacity lithium-ion secondary battery also suitable for low voltage applications is obtained.

The aspect of the invention may adopt a configuration in which the extraction electrode for a positive electrode and the extraction electrode for a negative electrode are disposed along different two sides of the substrate, respectively.

According to this configuration, the extraction electrodes having the same polarity can be easily connected to each other. Therefore, the unit battery layers can be easily connected in parallel through the plurality of extraction electrodes planarly disposed on the substrate. According to this, a large-capacity lithium-ion secondary battery also suitable for low voltage applications is obtained.

The aspect of the invention may adopt a configuration in which the extraction electrode has a strip shape extending along a side of the substrate.

According to this configuration, a forming region of the extraction electrode is large, and therefore, the connection place is not limited. Due to this, the extraction electrodes having the same polarity can be easily connected to each other. Therefore, the unit battery layers can be easily connected in parallel through the plurality of extraction electrodes planarly disposed on the substrate. According to this, a large-capacity lithium-ion secondary battery also suitable for low voltage applications is obtained.

The aspect of the invention may adopt a configuration in which the plurality of extraction electrodes are arranged in the width direction of the extraction electrodes.

According to this configuration, the extraction electrodes having the same polarity can be easily connected to each other. Therefore, the unit battery layers can be easily connected in parallel through the plurality of extraction electrodes planarly disposed on the substrate. According to this, a large-capacity lithium-ion secondary battery also suitable for low voltage applications is obtained.

The aspect of the invention may adopt a configuration in which the plurality of extraction electrodes are arranged along one side of the substrate.

According to this configuration, a forming region of the plurality of extraction electrodes can be made small. Therefore, a small-sized terminal can be used as a connection terminal connected to the plurality of extraction electrodes. The size and weight of the lithium-ion secondary battery can be reduced by an amount corresponding to the amount of use of the small-sized connection terminal. Therefore, if the size and weight are the same, the capacity can be increased as compared with a conventional lithium-ion secondary battery.

The aspect of the invention may adopt a configuration in which the unit battery layers on both sides sandwiching the collector electrode layer have a symmetric layer structure with respect to the collector electrode layer.

According to this configuration, one collector electrode layer can be shared by two unit battery layers. The size and weight of the lithium-ion secondary battery can be reduced by an amount corresponding to the amount of the collector electrode layer which can be reduced. Therefore, if the size and weight are the same, the capacity can be increased as compared with a conventional lithium-ion secondary battery.

The aspect of the invention may adopt a configuration in which the battery includes a sealing film which covers at least a side surface of the stacked body, and the extraction electrode is formed on the upper surface of the collector electrode layer exposed from the sealing film.

According to this configuration, the entry of moisture from the side surface of the unit battery layer can be suppressed. Due to this, deterioration of the unit battery layer by reacting lithium with oxygen, moisture, or the like can be suppressed.

Further, a portion exposed from the sealing film in the collector electrode layer constitutes the extraction electrode. The unit battery layers can be connected in parallel through the plurality of extraction electrodes. According to this, a large-capacity lithium-ion secondary battery also suitable for low voltage applications is obtained.

### BRIEF DESCRIPTION OF DRAWINGS

FIG. 1 is a perspective view schematically showing a lithium-ion secondary battery 100 of a first embodiment.

FIG. 2 is a cross-sectional view schematically showing the lithium-ion secondary battery 100 of the first embodiment.

FIG. 3 is a plan view schematically showing the lithium-ion secondary battery 100 of the first embodiment.

FIG. 4 is a perspective view schematically showing a lithium-ion secondary battery 101 of a second embodiment.

FIG. 5 is a plan view schematically showing the lithium-ion secondary battery 101 of the second embodiment.

### DESCRIPTION OF EMBODIMENTS

### First Embodiment

### [Lithium-Ion Secondary Battery]

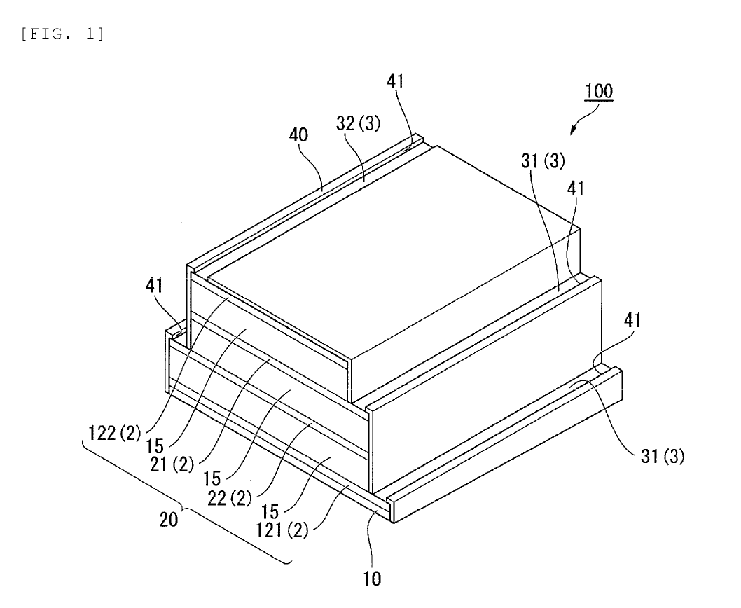

Hereinafter, a lithium-ion secondary battery 100 of a first embodiment will be described with reference to FIGS. 1 to 3. Incidentally, in all drawings below, in order to make the drawings easy to see, the dimensions, ratios, and the like of the respective constituent elements are appropriately made different.

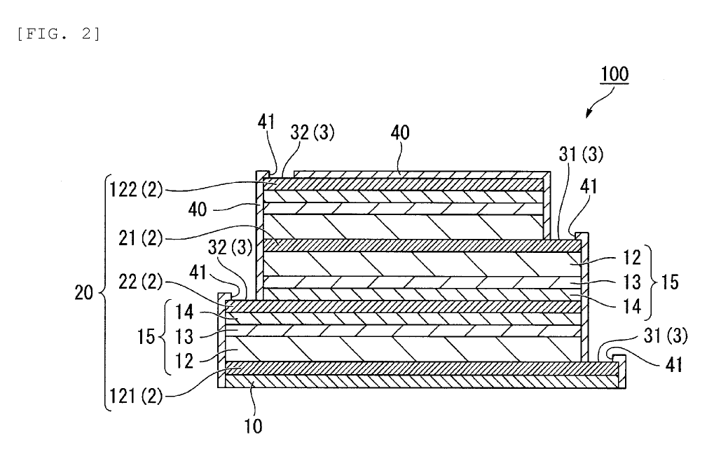

FIG. 1 is a perspective view schematically showing the lithium-ion secondary battery 100 of the first embodiment. FIG. 2 is a cross-sectional view schematically showing the lithium-ion secondary battery 100 of the first embodiment.

As shown in FIGS. 1 and 2, the lithium-ion secondary battery 100 includes a substrate 10, a stacked body 20 provided on the substrate 10, and a sealing film 40 covering almost the whole of the substrate 10 and the stacked body 20.

As a forming material of the substrate 10, for example, a metal material, a polymer material, or the like is used. Specific examples of the metal material include copper, stainless steel, aluminum, nickel, and the like. Specific examples of the polymer material include polyethylene terephthalate, polyethylene naphthalate, polyimide, and the like.

The surface of the substrate 10 composed of a polymer material may be covered with a metal thin film of copper or the like. The metal thin film can suppress the entry of oxygen, moisture, or the like into the below-mentioned unit battery layer 15 from the substrate 10. By forming the metal thin film, deterioration of the unit battery layer 15 by reacting lithium with oxygen, moisture, or the like can be suppressed.

The thickness of the substrate 10 is preferably 1.5 μm or more and 30 μm or less.

The stacked body 20 is constituted by alternately stacking a plurality of unit battery layers 15 and a plurality of collector electrode layers 2. The number of unit battery layers 15 in the stacked body 20 is preferably 100 or more and 3000 or less. At each of the both ends in the stacking direction of the stacked body 20, the collector electrode layer 2 is disposed.

The unit battery layers 15 on both sides sandwiching the collector electrode layer 2 have a symmetric layer structure with respect to the collector electrode layer 2. According to this, one collector electrode layer 2 can be shared by two unit battery layers 15. The size and weight of the lithium-ion secondary battery 100 can be reduced by an amount corresponding to the amount of the collector electrode layer 2 which can be reduced. Therefore, if the size and weight are the same, the capacity can be increased as compared with a conventional lithium-ion secondary battery.

The unit battery layer 15 has a positive electrode active material layer 12, a negative electrode active material layer 14, and a solid electrolyte layer 13 interposed between the positive electrode active material layer 12 and the negative electrode active material layer 14.

As a forming material of the positive electrode active material layer 12, for example, a composite oxide of lithium and a transition metal, a phosphate salt of lithium and a transition metal, and the like are exemplified.

Specific examples thereof include LiCoO₂, LiMn₂O₄, LiFePO₄, Li(Ni_{1/3}Mn_{1/3}Co_{1/3})O₂, a composite oxide represented by the general formula: LiNiₓMn_{y}Co_{(1-x-y)}O₂, a composite oxide represented by the general formula: NiNiₓCo_{y}Al_{(1-x-y)}O₂, and the like.

The electrical conductivity of the positive electrode active material layer 12 is preferably 10⁻⁶ S/m or more and 1 S/m or less, more preferably 10⁻⁶ S/m or more and 10⁻³ S/m or less. Further, the ion diffusion coefficient of the positive electrode active material layer 12 is preferably 1×10⁻¹⁶ m²/sec or more and 1×10⁻¹⁴ m²/sec or less.

The thickness of the positive electrode active material layer 12 is preferably 0.5 μm or more and 3 μm or less.

As a forming material of the negative electrode active material layer 14, for example, lithium, graphite, mesocarbon, non-graphitized carbon, lithium titanate, silicon, a lithium alloy, and the like are exemplified.

As a forming material of the solid electrolyte layer 13, a material having a lithium ion conduction property is used. As such a material, for example, a compound containing three or four elements selected from the group consisting of lithium, phosphorus, boron, sulfur, tungsten, and nitrogen is exemplified, and specifically, LiPO₄ is exemplified.

Further, as another example, it is also possible to use a polymer solid electrolyte having a lithium ion conduction property as the forming material of the solid electrolyte layer 13. As the polymer solid electrolyte, for example, polyethylene oxide (PEO), polypropylene oxide (PPO), polyvinylidene fluoride (PVDF), or a copolymer of these monomers, and the like are exemplified.

The polymer solid electrolyte may contain a lithium salt for enhancing the lithium ion conduction property. As the lithium salt, for example, LiBF₄, LiPF₆, LiN(SO₂CF₃)₂, LiN(SO₂C₂F₅)₂, a mixture thereof, or the like is used.

The thickness of the solid electrolyte layer 13 is preferably 0.1 μm or more and 0.5 μm or less.

The collector electrode layer 2 is a positive electrode collector electrode layer 21 or 121, or a negative electrode collector electrode layer 22 or 122, and in the case where both are not distinguished from each other, both are collectively referred to as “collector electrode layer 2”. The positive electrode collector electrode layer 21 or 121 is disposed on the side of the positive electrode active material layer 12 of the unit battery layer 15. The negative electrode collector electrode layer 22 or 122 is disposed on the side of the negative electrode active material layer 14 of the unit battery layer 15. Therefore, on both sides of the positive electrode collector electrode layer 21 and the negative electrode collector electrode layer 22, the stacking order of the respective layers constituting the unit battery layer 15 is reversed. As shown in FIG. 2, the positive electrode active material layer 12, the solid electrolyte layer 13, and the negative electrode active material layer 14 are disposed in this order from the side closer to the positive electrode collector electrode layer 21, and the negative electrode active material layer 14, the solid electrolyte layer 13, and the positive electrode active material layer 12 are disposed in this order from the side closer to the negative electrode collector electrode layer 22.

The stacked body 20 is obtained by stacking four collector electrode layers 2 and three unit battery layers 15. In the stacked body 20, the positive electrode collector electrode layer 121 is disposed on an end face having a wider area when viewed from the stacking direction, and the negative electrode collector electrode layer 122 is disposed on an end face having a narrower area when viewed from the stacking direction. On the positive electrode collector electrode layer 121, the substrate 10 is disposed. The negative electrode collector electrode layer 122 is covered with the sealing film 40 having an opening portion 41.

Incidentally, in the stacked body 20, the positive electrode collector electrode layer 121 is disposed on the end face having a wider area when viewed from the stacking direction, and the negative electrode collector electrode layer 122 is disposed on the end face having a narrower area, however, the positive electrode collector electrode layer 121 and the negative electrode collector electrode layer 122 may be disposed reversely. In this case, the stacking order of the respective layers constituting the unit battery layer 15 is reversed. Further, the number of unit battery layers 15 in the stacked body 20 is not particularly limited, and may be an odd number or an even number. In the case where the number of unit battery layers 15 is an even number, the collector electrode layers 2 on both end faces of the stacked body 20 have the same polarity.

As a forming material of the collector electrode layer 2, a metal material which has a high electrical conduction property and is less likely to react with another material constituting the lithium-ion secondary battery 100.

As the metal material to be used for the positive electrode collector electrode layer 21 or 121, for example, aluminum or an alloy thereof and the like are exemplified.

As the metal material to be used for the negative electrode collector electrode layer 22 or 122, for example, copper or an alloy thereof and the like are exemplified.

The thickness of the collector electrode layer 2 is preferably 30 nm or more and 100 nm or less.

The electrical conductivity of the collector electrode layer 2 is preferably 10⁷ S/m or more.

The sealing film 40 is formed so as to cover the upper surface and the side surfaces of the stacked body 20. The sealing film 40 suppresses the entry of moisture from the side surfaces of the unit battery layer 15. By forming the sealing film 40, deterioration of the unit battery layer 15 by reacting lithium with oxygen, moisture, or the like can be suppressed.

Further, in this embodiment, in the lithium-ion secondary battery 100, the sealing film 40 covers the whole except for the below-mentioned extraction electrodes 3 and the back surface, and therefore, the lithium-ion secondary battery 100 hardly causes a short circuit, and has excellent handling property and installation property.

In this embodiment, the surface of the stacked body 20 other than the below-mentioned extraction electrode 3 formed in the opening portion 41 is covered with the sealing film 40, and therefore, a short circuit hardly occurs also when the extraction electrodes 3 having the same polarity are electrically connected to each other.

The sealing film 40 has the opening portion 41 on the upper surface of each collector electrode layer 2. In this embodiment, a portion exposed on the inside of the opening portion 41 in the collector electrode layer 2 can be used as the extraction electrode 3. That is, on the upper surface of each collector electrode layer 2, the extraction electrode 3 is provided. The extraction electrode 3 is an extraction electrode 31 for a positive electrode or an extraction electrode 32 for a negative electrode, and in the case where both are not distinguished from each other, both are collectively referred to as “extraction electrode 3”. The extraction electrode 3 is for extracting electricity from the lithium-ion secondary battery 100 to the outside, and is electrically conducted to the collector electrode layer 2.

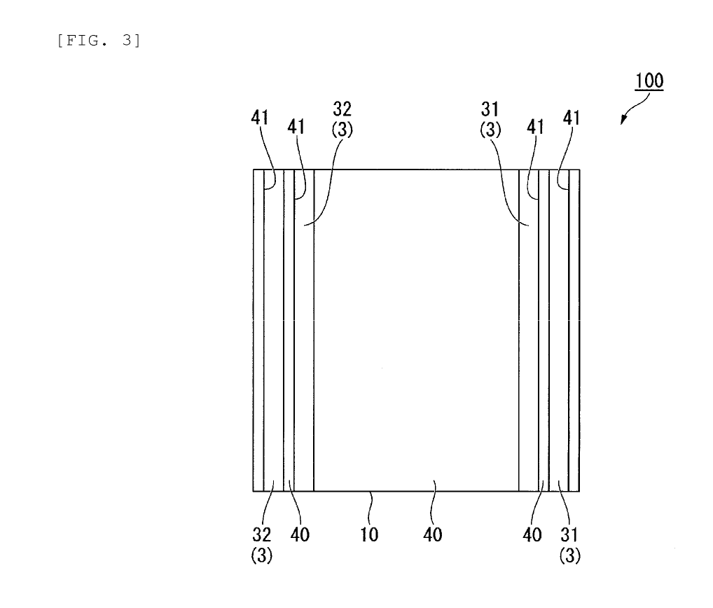

FIG. 3 is a plan view schematically showing the lithium-ion secondary battery 100 of the first embodiment. As shown in FIG. 3, the extraction electrode 31 for a positive electrode and the extraction electrode 32 for a negative electrode are disposed along different two sides of the substrate 10.

As shown in FIG. 2, on the upper side of one collector electrode layer 2, a layer having a smaller plane area than this collector electrode layer 2 is formed. In the case of this embodiment, the width in the horizontal direction of the unit battery layer 15 gradually becomes narrower as it goes up in the stacking direction from the substrate 10. According to this, a portion of the upper surface of each collector electrode layer 2 is exposed, and therefore, a plurality of extraction electrodes 3 can be formed in the exposed portions of these collector electrode layers 2. As a result, as shown in FIG. 3, the extraction electrode 3 in a strip shape extending along one side of the substrate 10 is formed on a side edge portion of the substrate 10. In this embodiment, on one side edge portion, the extraction electrode 3 located on the relatively lower layer side (on the side closer to substrate 10) is located on the relatively outer peripheral side. That is, the arrangement direction of the plurality of extraction electrodes 3 is the width direction of the extraction electrodes 3, and therefore, the forming region of the extraction electrodes 3 is increased, and the connection place of the extraction electrodes 3 is not limited. As a result, the extraction electrodes 3 having the same polarity can be easily connected to each other, and a configuration in which the capacity is large and the unit battery layers 15 can be easily connected in parallel can be achieved.

As a forming material of a wire or the like further connected to the extraction electrode 3, a metal such as copper can be used. Further, other than this, a metal such as aluminum or stainless steel, or an alloy material containing such a metal or a metal paste material containing such a metal can be used similarly.

Further, the extraction electrode 3 may be formed by disposing a material different from the collector electrode layer 2 in the opening portion 41 of the sealing film 40. In this case, as the material of the extraction electrode 3, aluminum, copper, silver, gold, or an alloy containing one or more of these elements can be used.

In the first embodiment, in order to suppress a reaction between lithium and moisture contained in the substrate 10, a barrier layer may be provided between the substrate 10 and the stacked body 20.

As a forming material of the barrier layer, for example, an oxide, a nitride, and a phosphate of at least one metal selected from the group consisting of Group 4 elements, Group 10 elements, Group 11 elements, and Group 13 elements in the periodic table are preferred. Specifically, aluminum oxide, silicon oxide, lithium phosphate represented by the general formula: LiₓPO_{y} (x+y≤7), titanium nitride, tantalum nitride, or a mixture thereof, and the like are exemplified.

The thickness of the barrier layer is preferably 30 nm or more and 100 nm or less.

In the lithium secondary battery of this embodiment having the above-mentioned configuration, the stacked body 20 in which a plurality of unit battery layers 15 are integrated is constituted by stacking the plurality of unit battery layers 15 through the collector electrode layer 2. Then, in the plurality of collector electrode layers 2, the extraction electrodes 3 are disposed at positions which do not planarly overlap with each other, and therefore, the extraction electrodes 3 having the same polarity can be easily connected to each other. Therefore, according to this embodiment, the lithium-ion secondary battery 100, in which the capacity is large and parallel connection is achieved, and which can be suitably used also for low voltage applications, is obtained.

### [Method for Producing Lithium-Ion Secondary Battery]

Next, a method for producing the lithium-ion secondary battery 100 according to the first embodiment will be described.

In the method for producing the lithium-ion secondary battery 100, first, on the substrate 10, a desired number of layers are stacked in the order of the positive electrode collector electrode layer 121 (21), the positive electrode active material layer 12, the solid electrolyte layer 13, the negative electrode active material layer 14, and the negative electrode collector electrode layer 122 (22). The film formation of each layer constituting the lithium-ion secondary battery 100 can be performed by a known film formation method. As the known film formation method, for example, vapor deposition, a physical vapor deposition method (PVD), a chemical vapor deposition method (CVD), sputtering, high-frequency magnetron spattering, microwave plasma enhanced chemical vapor deposition method (MPECVD), pulse laser deposition (PLD), laser abrasion, spray deposition, spray pyrolysis, spray coating, an aerosol deposition method, or plasma thermal spraying, and the like are exemplified.

As shown in FIG. 1 or 2, in order to form the respective layers such that the plane area of each layer formed on the collector electrode layer 2 is smaller than the plane area of the collector electrode layer 2, a formation method shown below is exemplified. As this formation method, for example, a method using a mechanical mask when forming each layer by the above-mentioned film formation method is exemplified. Further, as another formation method, a method in which after the respective layers are formed to have the same plane area, the layers are shaped to have a desired size by a known etching method is exemplified.

Subsequently, the sealing film 40 is formed on the side surfaces of the substrate 10, the side surfaces of the unit battery layer 15, and the side surfaces and the upper surface of the collector electrode layer 2. The formation of the sealing film 40 can be performed by the above-mentioned film formation method or photolithography. In the case where the above-mentioned film formation method is used, the opening portion 41 of the sealing film 40 can be formed using a mechanical mask. Further, in the case where photolithography is used, a patterning method using a photomask is exemplified.

According to the production method as described above, a large-capacity lithium-ion secondary battery 100 also suitable for low voltage applications is obtained.

### Second Embodiment

### [Lithium-Ion Secondary Battery]

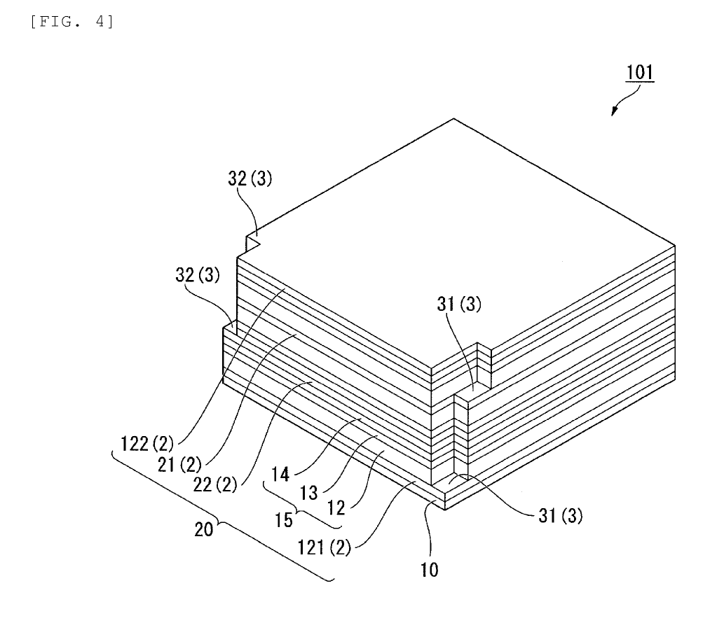

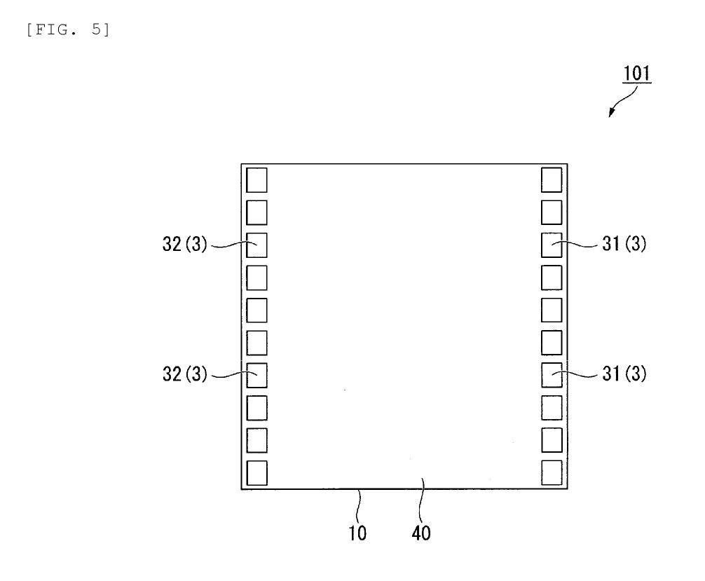

Hereinafter, a lithium-ion secondary battery 101 of a second embodiment will be described with reference to FIGS. 4 and 5. The basic configuration of the lithium-ion secondary battery 101 according to the second embodiment is the same as the first embodiment, and the shape of each layer formed on the collector electrode layer 2, and the disposition of the extraction electrode 3 are different from the first embodiment. Therefore, the description of the entire lithium-ion secondary battery will be omitted, and only these different points will be described.

FIG. 4 is a perspective view schematically showing the lithium-ion secondary battery 101 of the second embodiment. However, a sealing film 40 is not shown. FIG. 5 is a plan view schematically showing the lithium-ion secondary battery 101 of the second embodiment. However, the number of extraction electrodes 3 in FIG. 4 and FIG. 5 is made different.

As shown in FIG. 4, a stacked body 20 has a portion formed into a step-like shape in a region along two sides of a substrate 10. The collector electrode layer 2 formed immediately above the substrate 10 has substantially the same rectangular shape as the substrate 10, however, each layer formed on the upper side of the collector electrode layer 2 described above has a cutout portion at one or two corner portions. In the stacked body 20, the cutout portion of each layer becomes larger than the cutout portion of the lower layer at every insertion of the collector electrode layer 2 sequentially from the substrate 10 side. According to this configuration, a portion of the upper surface of each collector electrode layer 2 is exposed on the cutout portion. In the exposed portion of such a collector electrode layer 2, the extraction electrode 3 is formed.

In this embodiment, the plurality of extraction electrodes 31 for a positive electrode are located on the step-like portion of one side edge (the side edge on the right side of the drawing) of the substrate 10, and the plurality of extraction electrodes 32 for a negative electrode are located on the step-like portion of the other side edge (the side edge on the left side of the drawing) of the substrate 10. According to this, as shown in FIG. 5, the extraction electrodes 31 for a positive electrode and the extraction electrodes 32 for a negative electrode are arranged along different sides of the substrate 10, respectively.

According to the configuration as described above, also in the second embodiment, in the same manner as in the first embodiment, a large-capacity lithium-ion secondary battery 101 also suitable for low voltage applications is obtained. Further, in the second embodiment, the arrangement direction of the plurality of extraction electrodes 3 is the direction along the sides of the substrate 10, and therefore, as compared with the first embodiment, the forming region of the extraction electrodes 3 can be made smaller. According to this, a small-sized terminal can be used as a connection terminal connected to the extraction electrodes 3. The size and weight of the lithium-ion secondary battery 101 can be reduced by an amount corresponding to the amount of use of the small-sized connection terminal. Therefore, if the size and weight are the same, the capacity can be increased as compared with a conventional lithium-ion secondary battery.

### REFERENCE SINGS LIST

2: collector electrode layer, 3: extraction electrode, 10: substrate, 12: positive electrode active material layer, 13: solid electrolyte layer, 14: negative electrode active material layer, 15: unit battery layer, 20: stacked body, 21, 121: positive electrode collector electrode layer, 22, 122: negative electrode collector electrode layer, 31: extraction electrode for positive electrode, 32: extraction electrode for negative electrode, 40: sealing film, 41: opening portion, 100, 101: lithium-ion secondary battery

1. A lithium-ion secondary battery, comprising:
a substrate; and
a battery layer which has a positive electrode active material layer, a negative electrode active material layer, and an electrolyte layer between the positive electrode active material layer and the negative electrode active material layer; and
a collector electrode layer which has an extraction electrode planarly disposed on the substrate,
wherein the battery layer and the collector electrode layer form a stacked body while alternately stacking on the substrate.

2. The lithium-ion secondary battery according to claim 1, wherein
in the stacked body, the area of another layer formed on each of the collector electrode layers is smaller than the area of the collector electrode layer.

3. The lithium-ion secondary battery according to claim 1, wherein
the extraction electrode for a positive electrode and the extraction electrode for a negative electrode are disposed along different two sides of the substrate, respectively.

4. The lithium-ion secondary battery according to claim 1, wherein
the extraction electrode has a strip shape extending along a side of the substrate.

5. The lithium-ion secondary battery according to claim 4, wherein
the plurality of extraction electrodes are arranged in the width direction of the extraction electrodes.

6. The lithium-ion secondary battery according to claim 1, wherein
the plurality of extraction electrodes are arranged along one side of the substrate.

7. The lithium-ion secondary battery according to claim 1, wherein
the unit battery layers on both sides sandwiching the collector electrode layer have a symmetric layer structure with respect to the collector electrode layer.

8. The lithium-ion secondary battery according to claim 1, wherein
the battery includes a sealing film which covers at least a side surface of the stacked body, and
the extraction electrode is formed on the upper surface of the collector electrode layer exposed from the sealing film.
